(19) United States
(12) Patent Application Publication
(10) Pub. No.: US 2009/0107390 A1
(43) Pub. Date: Apr. 30, 2009

(54) Boat and vehicle flag mounting device

(76) Inventors: Clinton Lyle, Trussville, AL (US); William T. Lyle, JR., Trussville, AL (US)

Correspondence Address: BRADLEY ARANT BOULT CUMMINGS LLP, 200 CLINTON AVE. WEST, SUITE 900, HUNTSVILLE, AL, 35801, US

(21) Appl. No.: 11/978,437

(22) Filed: Oct. 29, 2007

(51) Int. Cl. G09F 17/00

(52) U.S. Cl. 116/173

(57) ABSTRACT

The invention provides a device to removeably attach a flag to a ball hitch comprising a proximate end and a terminal end, where the proximate end has a plurality of fingers and where one end of each of the fingers is attached to a mast.

### FIELD OF THE INVENTION

The invention relates generally to an apparatus to secure a flag to a boating water-ski tow hitch, wakeboard tow hitch or other ball type hitch.

### BACKGROUND ART

Sports' fans have long attached flags and banners to their vehicle windows by various products. However, these products cannot be used if the vehicle has rain guards above the windows. Further, by attaching to the sides of a vehicle, the flags are exposed to the full force of air flow surrounding a moving vehicle. This results in the pre-mature deterioration of the flag fabric, the mounting device and deforms the window seal. Sports' fans do not currently have an adequate way to removably attach a flag or banner to a ski boat or wake boarding boat. Many vehicles, ski boats, and wake board boats make use of ball type hitches. The vehicles use ball hitches to attach trailers, boats use ball hitches to attach ski ropes or wake board ropes.

The prior art teaches devices for attaching antennas and the like to a ball hitch, but the prior art fails to provide a simple manner of removably attaching a flag mast to a ball hitch in such a way that the attachment is secure while the vehicle is in motion and yet easily and conveniently removable. Further, the prior art fails to teach a device to attach a mast to a ball hitch which is also protected from the harsh corrosive environments of boating. Thus, a convenient device to removably attach a flag mast to a ball hitch is needed. Preferably, such a device would also be impervious to the harsh environments caused by salt water spray that many boats are exposed to.

### SUMMARY OF THE INVENTION

In some aspects, the invention relates to a flag mounting device comprising a proximate end and a terminal end, where the terminal end has a cap and a flag mast is located below the cap and a flag is attached to the mast. The proximate end has a plurality of fingers. The fingers are configured to attach to a ball hitch. An O-ring fits around the fingers and compresses the fingers around the base of the ball hitch.

In other aspects, the invention relates to a flag mounting device comprising a proximate end and a terminal end, where the proximate end has a plurality of fingers. Each of the plurality of fingers has two ends, one such end is affixed to a mast.

In other aspects, the invention relates to a flag mounting device comprising a proximate end and a terminal end, where the proximate end has a plurality of fingers. Each of the plurality of fingers has two ends, one such end is affixed to a mast and the other end of each of the fingers is loosely connected by an O-ring.

In other aspects of the invention, the plurality of fingers is assembled radially around the mast, which creates a center void. An O-ring may be used with a diameter less then the diameter of the center void. In this aspect, the O-ring helps secure the device to the ball hitch.

In other aspects, the invention relates to a flag mounting device comprising a flag and a means for attaching the flag to a mast and a means for attaching the mast to a ball hitch.

In other aspects, the invention relates to a flag mounting device comprising a means for attaching a flag to a mast and a means for attaching the mast to a ball hitch.

### BRIEF DESCRIPTION OF DRAWINGS

It should be noted that identical features in different drawings are shown with the same reference numeral.

FIG. 1 illustrates a perspective view of one embodiment of the present invention.

FIG. 2 illustrates a detailed view of the proximate end of one embodiment of the current invention.

FIG. 3 illustrate a detailed view of the proximate end of one embodiment of the current invention while the invention is in use, mounted to a ball hitch.

### DETAILED DESCRIPTION

The present invention discloses a device that removably yet securely attaches to a ball hitch a mast to which a flag, banner, foam finger, or other sports paraphernalia might be attached.

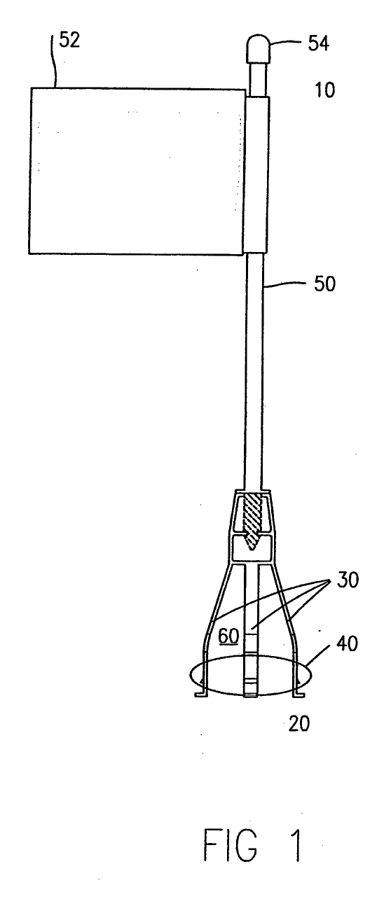

FIG. 1 shows one embodiment of the present invention. The present invention has a proximate end (20) and a terminal end (10). The proximate end has a plurality of flexible fingers (30). Preferably, the number of fingers is related to the size of the ball hitch. Thus, for a typical two inch (2″) ball hitch or a two and a five sixteenth inch (2 5/16″) ball hitch the preferred embodiment has eight fingers (30). Each finger (30) has a slight curvature such that when the plurality of fingers is assembled radially around a mast (50) a center void (60) is created in between the fingers (30). The fingers are loosely connected by an O ring (40) at the proximate end of the device. The other end of the fingers are firmly affixed to a mast (50). The mast (50) is suitable to accept a flag, banner, foam finger or other paraphernalia (52) and in some embodiments, such items may be integral to the mast. At the proximate end may be a end cap (54). Such end cap (54) may be removable. In other embodiments the end cap is integral to the mast. The end cap (54) discourages the flag or other paraphernalia (52) from lifting off of the mast (50).

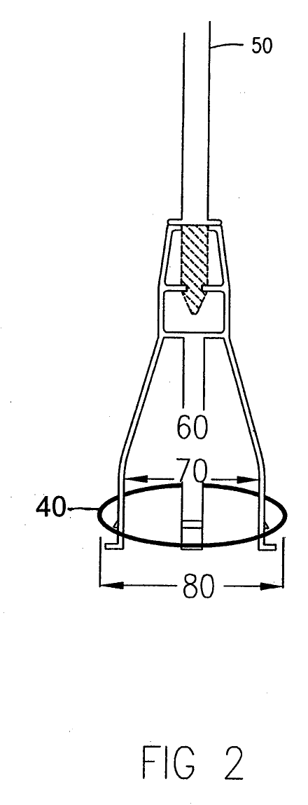

FIG. 2 shows a center void (60) created by the radially affixed fingers. The diameter of the center void (60) is slightly less than the diameter of the ball hitch that the device is intended for. Preferably, the diameter of the center void (60) is 1/16-⅛ inches smaller than the diameter of the intended ball hitch. Thus, for a two inch ball hitch the center void diameter (70) is preferably 1⅞ inches. In other embodiments greater or lesser dimensions may be used. The fingers are held together at the proximate end of the device by an O ring (40). The O ring has an inner diameter (80) less than the ball hitch for which the device is used. Preferably, for a two inch ball hitch the O ring inner diameter (80) is 1 1/14-1½ inches.

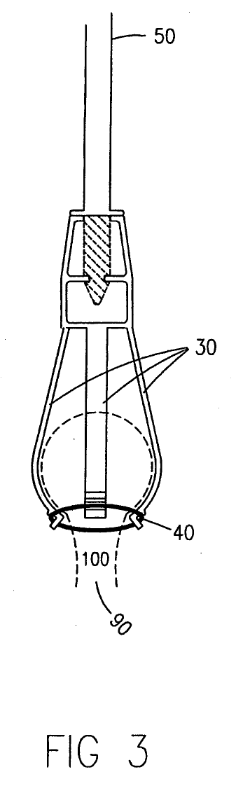

FIG. 3 shows the proximate end of the device mounted onto a ball hitch (90). When mounting the device to the ball hitch, the fingers (30) and O ring (40) expand outward to allow the insertion of the ball hitch (90). Once the O ring (40) is below the ball, the spring tension of the O ring encloses the fingers around the base of the ball (100). The slightly smaller diameter of the natural state of the center void keeps the fingers (30) in contact with the ball and the entire assembly is thus secured.

In an alternative embodiment, the entire device is made of non-corrosive materials such as (without limitation) plastic, fiberglass, or other inert material, preferably plastic except for the O-ring (40).

Preferably, the O ring (40) portion of the device is made of a known material with suitable elasticity, preferably, rubber, synthetic rubber or neoprene, most preferably neoprene.

The use of flexible fingers (30) in the device provides several advantages. The device, while securely attached (such that it would not fall off during use on a moving vehicle or boat), still allows for some movement during use. The device can freely turn on its axis around the ball hitch (90). Thus while being used on a boat, a flag (52), as used in some embodiments of the invention, can spin in a weathervane fashion. This prevents the flag (52) from becoming wrapped around the mast (50) which would hinder or prevent its ability to unfurl.

While intended for the purposes of mounting sports paraphernalia it is recognized that the device is also suitable for the display of other signage, allegiances, marketable communications, product identification, warnings, information and a variety of other forms of communication. All these forms of communication are collectively referred to throughout this specification and claims as a “flag”. Other aspects and advantages of the invention will be apparent from the following description and the appended claims.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A flag mounting device comprising:
a. A proximate end and a terminal end;
b. a cap located at the terminal end;
c. a mast located below the cap;
d. a flag attached to the mast;
e. fingers located at the proximate end, where the fingers are configured to attach to a ball hitch; and
f. an O-ring that fits around the fingers, where the O-ring compresses the fingers around the base of the ball hitch.

2. A flag mounting device comprising:
a. A proximate end and a terminal end;
b. where the proximate end has a plurality of fingers;
c. where each of the plurality of fingers has two ends; and
d. where one end of each of the fingers is attached to a mast.

3. A flag mounting device comprising:
a. A proximate end and a terminal end;
b. where the proximate end has a plurality of fingers;
c. where each of the plurality of fingers has two ends;
d. where one end of each of the fingers is attached to a mast; and
e. where the other end of each of the fingers is loosely connected by an O ring.

4. A flag mounting device as in claim 2 further comprising:
a. an end cap at the terminal end.

5. A flag mounting device as in claim 3 further comprising:
a. an end cap at the terminal end.

6. A flag mounting device as in claim 2 further comprising:
a. where the plurality of fingers is assembled radially around the mast creating a center void.

7. A flag mounting device as in claim 3 further comprising:
a. where the plurality of fingers is assembled radially around the mast creating a center void.

8. A flag mounting device as in claim 4 further comprising:
a. where the plurality of fingers is assembled radially around the mast creating a center void.

9. A flag mounting device as in claim 5 further comprising:
a. where the plurality of fingers is assembled radially around the mast creating a center void.

10. A flag mounting device as in claim 7 further comprising:
a. where the inner diameter of the O ring is less then the diameter of the center void.

11. A flag mounting device as in claim 9 further comprising:
a. where the inner diameter of the O ring is less then the diameter of the center void.

12. A flag mounting device comprising:
a. a flag
b. means for attaching the flag to a mast; and
c. means for attaching the mast to a ball hitch.

13. A flag mounting device comprising:
a. means for attaching a flag to a mast; and
b. means for attaching the mast to a ball hitch.
